(19) United States
(12) Patent Application Publication
(10) Pub. No.: US 2024/0364981 A1
(43) Pub. Date: Oct. 31, 2024

(54) METHOD, APPARATUS, AND MEDIUM FOR VIDEO PROCESSING

(71) Applicant: Bytedance Inc., Los Angeles, CA (US)

(72) Inventor: Ye-Kui WANG, Los Angeles, CA (US)

(21) Appl. No.: 18/770,528

(22) Filed: Jul. 11, 2024

Related U.S. Application Data
(63) Continuation of application No. PCT/US2023/060417, filed on Jan. 10, 2023.
(60) Provisional application No. 63/298,502, filed on Jan. 11, 2022.

(51) Int. Cl. H04N 21/854; H04N 21/845

(52) U.S. Cl. CPC H04N 21/85406; H04N 21/845

(57) ABSTRACT

Embodiments of the present disclosure provide a solution for video processing. A method for video processing is proposed. The method comprises: performing a conversion between a bitstream of a video and a media file of the video, wherein the media file comprises a group of labels comprising a first label, a first indication in a first data structure for the first label is coded with a single bit, and the first indication indicates whether the first label contains a summary label for the group of labels.

### CROSS REFERENCE TO RELATED APPLICATIONS

This application is a continuation of International Application No. PCT/US2023/060417, filed on Jan. 10, 2023, which claims the benefit of U.S. Provisional Application Ser. No. 63/298,502, and filed on Jan. 11, 2022. The entire contents of these applications are hereby incorporated by reference in their entireties.

### FIELD

Embodiments of the present disclosure relates generally to video processing techniques, and more particularly, to signaling of preselections in a media file.

### BACKGROUND

Media streaming applications are typically based on the internet protocol (IP), transmission control protocol (TCP), and hypertext transfer protocol (HTTP) transport methods, and typically rely on a file format such as the ISO base media file format (ISOBMFF). One such streaming system is dynamic adaptive streaming over HTTP (DASH). In DASH, there may be multiple representations for video and/or audio data of multimedia content, different representations may correspond to different coding characteristics (e.g., different profiles or levels of a video coding standard, different bitrates, different spatial resolutions, etc.). Moreover, preselection is a set of one or multiple media components representing one version of the media presentation that may be selected by a user for simultaneous decoding and presentation. Therefore, it is worth studying on signaling of preselections in a media file.

### SUMMARY

Embodiments of the present disclosure provide a solution for video processing.

In a first aspect, a method for video processing is proposed. The method comprises: performing a conversion between a bitstream of a video and a media file of the video, wherein the media file comprises a group of labels comprising a first label, a first indication in a first data structure for the first label is coded with a single bit, and the first indication indicates whether the first label contains a summary label for the group of labels.

According to the method in accordance with the first aspect of the present disclosure, an indication indicating whether a label contains a summary label for the group of labels is coded with a single bit. Compared with the conventional solution where such an indication is coded with 8 bits, the proposed method can advantageously reduce the number of bits for signaling the indication and thus improve the coding efficiency.

In a second aspect, an apparatus for processing video data is proposed. The apparatus for processing video data comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by a video processing apparatus. The method comprises: performing a conversion between the bitstream and a media file of the video, wherein the media file comprises a group of labels comprising a first label, a first indication in a first data structure for the first label is coded with a single bit, and the first indication indicates whether the first label contains a summary label for the group of labels.

In a fifth aspect, a method for storing a bitstream of a video is proposed. The method comprises: performing a conversion between the bitstream and a media file of the video; and storing the bitstream in a non-transitory computer-readable recording medium, wherein the media file comprises a group of labels comprising a first label, a first indication in a first data structure for the first label is coded with a single bit, and the first indication indicates whether the first label contains a summary label for the group of labels.

In a sixth method, another non-transitory computer-readable recording medium is proposed. The non-transitory computer-readable recording medium stores a media file of a video which is generated by a method performed by a video processing apparatus. The method comprises: performing a conversion between a bitstream of the video and the media file, wherein the media file comprises a group of labels comprising a first label, a first indication in a first data structure for the first label is coded with a single bit, and the first indication indicates whether the first label contains a summary label for the group of labels.

In a seventh aspect, a method for storing a media file of a video is proposed. The method comprises: performing a conversion between a bitstream of the video and the media file; and storing the media file in a non-transitory computer-readable recording medium, wherein the media file comprises a group of labels comprising a first label, a first indication in a first data structure for the first label is coded with a single bit, and the first indication indicates whether the first label contains a summary label for the group of labels.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a flowchart of a method for video processing in accordance with some embodiments of the present disclosure; and

FIG. 5 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

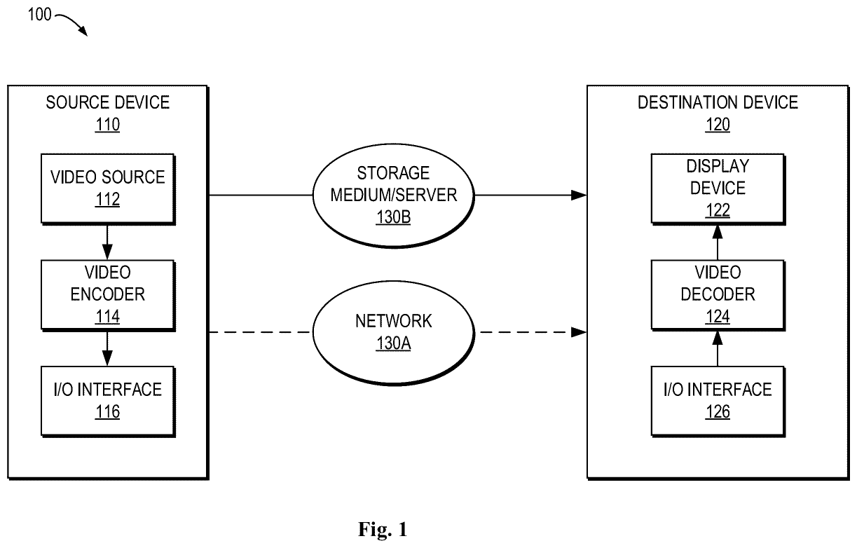

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

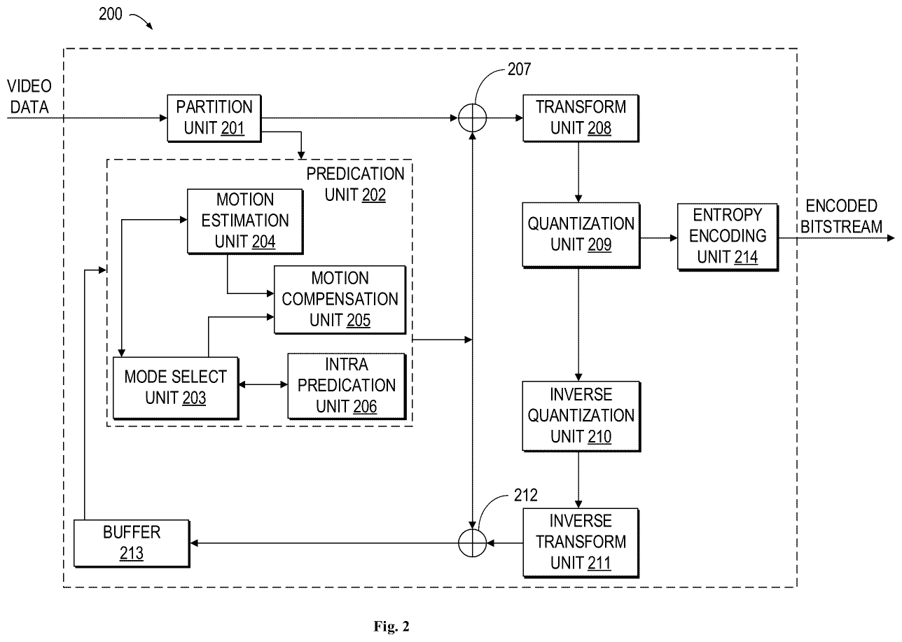

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

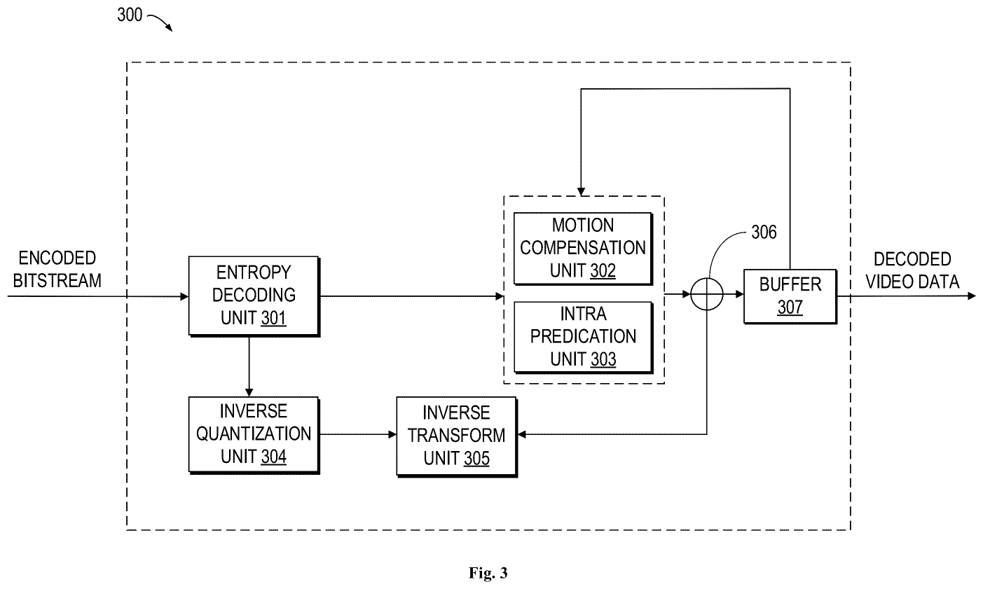

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. SUMMARY

This disclosure is related to media file formats. Specifically, it is related to signalling of preselections in a media file, wherein a preselection is a set of one or multiple media components representing one version of the media presentation that may be selected by a user for simultaneous decoding and presentation. The ideas may be applied individually or in various combination, to media files according to any media file formats, e.g., the ISO base media file format (ISOBMFF) and file format derived from the ISOBMFF.

### 2. BACKGROUND

### 2.1 Video Coding Standards

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET was later renamed to be the Joint Video Experts Team (JVET) when the Versatile Video Coding (VVC) project officially started. VVC is the new coding standard, targeting at 50% bitrate reduction as compared to HEVC, that has been finalized by the JVET at its 19th meeting ended at Jul. 1, 2020.

The Versatile Video Coding (VVC) standard (ITU-T H.266 I ISO/IEC 23090-3) and the associated Versatile Supplemental Enhancement Information (VSEI) standard (ITU-T H.274 ISO/IEC 23002-7) have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

### 2.2 File Format Standards

Media streaming applications are typically based on the IP, TCP, and HTTP transport methods, and typically rely on a file format such as the ISO base media file format (ISOBMFF). One such streaming system is dynamic adaptive streaming over HTTP (DASH). For using a video format with ISOBMFF and DASH, a file format specification specific to the video format, such as the AVC file format and the HEVC file format, would be needed for encapsulation of the video content in ISOBMFF tracks and in DASH representations and segments. Important information about the video bitstreams, e.g., the profile, tier, and level, and many others, would need to be exposed as file format level metadata and/or DASH media presentation description (MPD) for content selection purposes, e.g., for selection of appropriate media segments both for initialization at the beginning of a streaming session and for stream adaptation during the streaming session. Similarly, for using an image format with ISOBMFF, a file format specification specific to the image format, such as the AVC image file format and the HEVC image file format, would be needed.

### 2.3 Preselection Signalling in the ISOBMFF

An amendment to the ISOBMFF standard is being developed. The latest draft specification of this amendment includes the specification of some features for signalling of preselections.

The specification of the features for signalling of preselections are as follows.

### Changes to Containers of Boxes

Change the containers of the ‘elng’, ‘udta’, ‘kind’, and ‘chnl’ boxes such that these boxes may also be contained in the Preselection Information Box (‘prsi’).

### 3.1 Definitions

### Preselection

a set of one or multiple media components representing one version of the media presentation that may be selected by a user for simultaneous decoding/presentation.

### 8.3.4.4.3 Preselection Box

### 8.3.4.4.3.1 Definition

TrackGroupTypeBox with track_group_type equal to ‘pres’ indicates that this track contributes to a preselection.

The tracks that have the same value of track_group_id within PreselectionGroupBox are part of the same preselection.

Preselections can be qualified by language, kind or media specific attributes like audio rendering indications or channel layouts. Attributes signaled in a preselection box shall take precedence over attributes signaled in contributing tracks.

All attributes uniquely qualifying a preselection shall be present in at least one Preselection Box of the preselection. If present in more than one Preselection Box of the preselection, the boxes shall be identical.

NOTE: Preselections group tracks of the same media type only.

Tracks not containing all required media components for at least one preselection shall have the track_in_movie flag set to ‘0’ in their Track Header Boxes. This prevents players not understanding the Preselection Box from playing the track resulting in an incomplete experience.

NOTE: It is good practice to have one track with track_in_movie flag set to one. This implies that this track provides at least one complete experience.

### 8.3.4.4.3.2 Syntax

```
aligned(8) class PreselectionGroupBox extends
TrackGroupTypeBox(‘pres’)
{
  if (flags & 1) {
    unsigned int(8) selectionPriority=1
  }
  PreselectionInformationBox( )
    PreselectionProcessingBox( )
  }
```

### 8.3.4.4.3.3 Semantics

selection_priority is an integer that declares the priority of the preselection in cases where no other differentiation such as through the media language is possible. A lower number indicates a higher priority.

### 8.3.4.4.4 Preselection Information Box

### 8.3.4.4.4.1 Definition

Box Type: ‘prsi’
Container: Preselection Box
Mandatory: Yes
Quantity: Exactly One

This Box aggregates all semantic information about the preselection.

### 8.3.4.4.4.2 Syntax

```
aligned(8) class PreselectionInformationBox
  extends FullBox(‘prsi', version=0, 0 ){
  // Boxes describing the preselection
}
```

### 8.3.4.4.5 Preselection Processing Box

### 8.3.4.4.5.1 Definition

Box Type: ‘prsp’
Container: Preselection Box
Mandatory: Yes
Quantity: Exactly One

This box contains information how the tracks contributing to the preselection shall be processed. Media type specific boxes may be used to describe further processing.

### 8.3.4.4.5.2 Syntax

```
aligned(8) class PreselectionProcessingBox
  extends FullBox(‘prsp’, version=0, flags ){
  string preselection_tag;
  if (flags & 1) {
    unsigned int(8) order=0
  }
  // further attributes and Boxes defining additional processing of
  // the track contributing to the preselection
}
```

### 8.3.4.4.5.3 Semantics

preselection_tag is an integer that contains an identifier for the label. Labels with the same value belong to a label group. The default value of zero indicates that the label does not belong to any label group.
order specifies the conformance rules for Representations in Adaptation Sets within the Preselection according to ISO/IEC 23009-1 [ref], from the following enumerated set:
   0: undefined;
   1: time-ordered;
   2: fully-ordered.

### 8.18.4 Label and Group Label Box

### 8.18.4.1 Definition

Box Type: ‘labl’
Container: Container User data box (‘udta’) in a track, Preselection Information Box (‘prsi’)
Mandatory: No
Quantity: Zero or more

Labels provide the ability to annotate data structures in an ISOBMFF file to provide a description of the context of the element to which the label is assigned. Such labels may for example be used by playback clients to provide a selection choice to the user. The label may also be used for simple annotation in another context.

In addition, a GroupLabel element may be added on a higher level in order to provide a summary or title of the labels collected in a group. An example may be that this is used in a menu in order to provide a context of the menu of the labels.

Multiple Labels can be used to provide the textual description. To annotate the preselection to a multilingual audience, the annotation can be provided in a language different from that of the preselection.

If the is_group_label is set to a value different from zero, the label text in this box specifies a summary or title of all labels with the same label_id. This may be used as the title on a selection menu containing a collection of labels.

### 8.18.4.2 Syntax

| aligned(8) class LabelBox | |
|---|---|
| extends FullBox(‘labl’, version=0, 0 ){ | |
| unsigned int(8) | is_group_label =0; |
| unsigned int(16) | label_id = 0; |

```
  utf8string language;
  utf8string label;
}
```

### 8.18.4.3 Semantics

is_group_label specifies if the label contains a summary label for a group of labels.
label_id is an integer that contains an identifier for the label. Labels with the same value belong to a label group. The default value of zero indicates that the label does not belong to any label group.
language is a NULL-terminated C string containing an RFC 4646 (BCP 47) compliant language tag string, such as “en-US”, “fr-FR”, or “zh-CN”, the language being the language the label is targeted at.
label is a NULL-terminated C string containing the textual description.

### 8.18.5 Audio Rendering Indication Box

### 8.18.5.1 Definition

Box Type: ‘ardi’
Container: Preselection Information Box (‘prsi’)
Mandatory: No
Quantity: Zero or one

The audio rendering indication box contains a hint for a preferred reproduction channel layout.

### 8.18.5.2 Syntax

aligned(8) class AudioRenderingIndicationBox
extends FullBox('ardi', version=0, 0 ){
unsigned int(8) audio_rendering_indication = 0;
}

### 8.18.5.3 Semantics

audio_rendering_indication contains a hint for a preferred reproduction channel layout, coded according to the following table.

TABLE
Coding of audio rendering indication

| audio_{—} | |
|---|---|
| rendering_{—} | |
| indication | Description |
| 0 | no preference given for the reproduction channel layout |
| 1 | preferred reproduction channel layout is stereo |
| 2 | preferred reproduction channel layout is two-dimensional |
| | (e.g. 5.1 multi-channel) |
| 3 | preferred reproduction channel layout is three-dimensional |
| 4 | content is pre-rendered for consumption with headphones |
| 5 to 255 | reserved for future use |

### 3. PROBLEMS

The existing designs for signalling of preselections in the ISOBMFF have the following problems:
1) A requirement is specified such that tracks not containing all required media components for at least one preselection shall have the track_in_movie flag set to ‘0’ in their Track Header Boxes. However, some tracks may belong to no preselection track group, i.e., they may contain no TrackGroupTypeBox with track_group_type equal to ‘pres’. Imposing this requirement on such tracks would not be backward compatible issue with.
2) The 8-bit field is_group_label the LabelBox specifies whether the label contains a summary label for a group of labels. However, only one bit is sufficient for such a flag field.

### 4. DETAILED SOLUTIONS

To solve the above problem, methods as summarized below are disclosed. The solutions should be considered as examples to explain the general concepts and should not be interpreted in a narrow way. Furthermore, these solutions can be applied individually or combined in any manner.
1) To solve the first problem, the requirement of having the track_in_movie flag set to ‘0’ in the Track Header Box is not imposed on tracks that do not contain a TrackGroupTypeBox with track_group_type equal to ‘pres’.
   a. In one example, a TrackGroupTypeBox with track_group_type equal to ‘pres’ PreselectionGroupBox is also referred to as a PreselectionGroupBox or simply a Preselection Box.
   b. In one example, it is specified that tracks containing a PreselectionGroupBox and not containing all required media components for at least one preselection shall have the track_in_movie flag set to ‘0’ in their Track Header Boxes.
2) To solve the second problem, the field is_group_label in the LabelBox is coded using one bit.
   a. In one example, the field is_group_label in the LabelBox is coded using one bit, and the subsequent 7 bits are reserved for future use.
   b. In one example, the field is_group_label in the LabelBox is coded using one bit, and the preceding 7 bits are reserved for future use.

### 5. EMBODIMENTS

Below are some example embodiments for some of the solution aspects summarized above in Section 4. Most relevant parts that have been added or modified are shown by using bolded words (e.g., this format indicates added text), and some of the deleted parts are shown by using words in italics between double curly brackets (e.g., [[this format indicates deleted text]]). There may be some other changes that are editorial in nature and thus not highlighted. Parts that remain unchanged are not included. It should be understood that only markings in this section are intended to represent changes.

### 5.1 First Embodiment

This embodiment is for items 1, 1.a, 1.b, 2, and 2.a and 2.

### 8.3.4.4.3 Preselection Box

### 8.3.4.4.3.1 Definition

The presence of a TrackGroupTypeBox with track_group_type equal to ‘pres’, which is also referred to as a PreselectionGroupBox or simply a Preselection Box, in a track indicates that the track contributes to a preselection.

The tracks that have the same value of track_group_id within PreselectionGroupBox are part of the same preselection.

Preselections can be qualified by language, kind or media specific attributes like audio rendering indications or channel layouts. Attributes signalled in a preselection box shall take precedence over attributes signalled in contributing tracks.

All attributes uniquely qualifying a preselection shall be present in at least one Preselection Box of the preselection. If present in more than one Preselection Box of the preselection, the boxes shall be identical.

NOTE: Preselections group tracks of the same media type only.

Tracks containing a PreselectionGroupBox and not containing all required media components for at least one preselection shall have the track_in_movie flag set to ‘0’ in their Track Header Boxes. This prevents players not understanding the Preselection Box from playing the track resulting in an incomplete experience.

NOTE: It is good practice to have one track with track_in_movie flag set to one. This implies that this track provides at least one complete experience.

### 8.3.4.4.3.2 Syntax

```
aligned(8) class PreselectionGroupBox extends
TrackGroupTypeBox(‘pres’)
{
  if (flags & 1) {
    unsigned int(8) selectionPriority=1
  }
  PreselectionInformationBox( )
    PreselectionProcessingBox( )
  }
```

### 8.3.4.4.3.3 Semantics

selection_priority is an integer that declares the priority of the preselection in cases where no other differentiation such as through the media language is possible. A lower number indicates a higher priority.
. . .

### 8.18.4 Label and Group Label Box

### 8.18.4.1 Definition

Box Type: ‘labl’
Container: Container User data box (‘udta’) in a track, Preselection Information Box (‘prsi’)
Mandatory: No
Quantity: Zero or more

Labels provide the ability to annotate data structures in an ISOBMFF file to provide a description of the context of the element to which the label is assigned. Such labels may for example be used by playback clients to provide a selection choice to the user. The label may also be used for simple annotation in another context.

In addition, a GroupLabel element may be added on a higher level in order to provide a summary or title of the labels collected in a group. An example may be that this is used in a menu in order to provide a context of the menu of the labels.

Multiple Labels can be used to provide the textual description. To annotate the preselection to a multilingual audience, the annotation can be provided in a language different from that of the preselection.

If the is_group_label is set to a value different from zero, the label text in this box specifies a summary or title of all labels with the same label_id. This may be used as the title on a selection menu containing a collection of labels.

### 8.18.4.2 Syntax

| aligned(8) class LabelBox | |
|---|---|
| | extends FullBox(‘labl’, version=0, 0 ){ |
| {{ | unsigned int(8) is_group_label = 0;}} |
| | unsigned int(1) is_group_label = 0; |
| | bit(7) reserved = 0; |
| | unsigned int(16) label_id = 0; |
| | utf8string language; |
| | utf8string label; |

}

### 8.18.4.3 Semantics

is_group_label specifies if the label contains a summary label for a group of labels.
label_id is an integer that contains an identifier for the label. Labels with the same value belong to a label group. The default value of zero indicates that the label does not belong to any label group.
language is a NULL-terminated C string containing an RFC 4646 (BCP 47) compliant language tag string, such as “en-US”, “fr-FR”, or “zh-CN”, the language being the language the label is targeted at.
label is a NULL-terminated C string containing the textual description.

More details of the embodiments of the present disclosure will be described below which are related to signaling of preselections in a media file. The embodiments of the present disclosure should be considered as examples to explain the general concepts and should not be interpreted in a narrow way. Furthermore, these embodiments can be applied individually or combined in any manner.

As used herein, the term “preselection” may refer to a set of one or more tracks representing one version of the media presentation for simultaneous decoding or presentation. The term “track” may refer to a timed sequence of related samples. The term “box” may refer to an object-oriented building block defined by a unique type identifier and length.

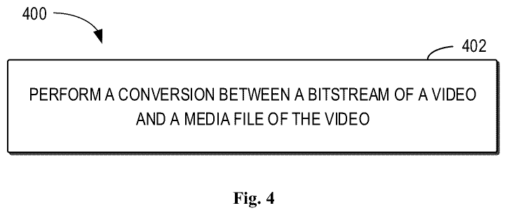

FIG. 4 illustrates a flowchart of a method 400 for video processing in accordance with some embodiments of the present disclosure. The method 400 may be implemented at a client or a server. The term “client” used herein may refer to a piece of computer hardware or software that accesses a service made available by a server as part of the client-server model of computer networks. By way of example, the client may be a smartphone or a tablet. The term “server” used herein may refer to a device capable of computing, in which case the client accesses the service by way of a network. The server may be a physical computing device or a virtual computing device.

As shown in FIG. 4, at 402, a conversion between a bitstream of a video and a media file of the video is performed. A media file is a collection of data that establishes a bounded or unbounded presentation of media content in the context of a file format, e.g., the international organization for standardization (ISO) base media file format. In some embodiments, the conversion may comprise generating the media file and storing the bitstream to the media file. Additionally or alternatively, the conversion may comprise parsing the media file to reconstruct the bitstream.

In some embodiments, the media file comprises a group of labels comprising a first label. A label may provide the ability to annotate data structures in a media file to provide a description of the context of the entity to which the label is assigned. Moreover, a first indication in a first data structure for the first label is coded with a single bit. The first indication indicates whether the first label contains a summary label for the group of labels. For example, the first data structure may be a label box (also noted ad LabelBox), and the first indication may be an is_group_label field. In one example, the group of labels may have the same identifier. The summary label may comprise a summary or a title of all of the group of labels.

In view of the above, an indication indicating whether a label contains a summary label for the group of labels is coded with a single bit. Compared with the conventional solution where such an indication is coded with 8 bits, the proposed method can advantageously reduce the number of bits for signaling the indication and thus improve the coding efficiency.

In some embodiments, a predetermined number of bits immediately following the single bit may be reserved. Alternatively, a predetermined number of bits immediately preceding the single bit may be reserved. By way of example rather than limitation, the predetermined number may be 7. These bits may be reserved for future use or for any other suitable purpose. The scope of the present disclosure is not limited in this respect.

In some embodiments, a requirement specifying that a second indication in a second data structure in a track has a predetermined value may be not imposed on at least one track in the media file. The second indication may indicate whether the corresponding track represents a direct part of a presentation of the media file. The second data structure may specify characteristics of the corresponding track. The at least one track does not contribute to a preselection for the media file. In one example, the at least one track does not contain a track group type box (also noted as TrackGroupTypeBox) with a track group type field (also noted as track_group_type field) equal to ‘pres’. The second indication may be a track_in_movie flag, and second data structure may be a track header box (also noted as TrackHeaderBox). By way of example rather than limitation, the predetermined value may be 0. It should be understood that the above illustrations and/or examples are described merely for purpose of description. The scope of the present disclosure is not limited in this respect.

In some embodiments, a track group type box with a track group type field equal to ‘pres’ may be a preselection group box (also noted as PreselectionGroupBox). In some embodiments, the media file may comprise a set of target tracks. Each of the set of target tracks contains the preselection group box and lacks one or more required media components for at least one preselection for the media file. That is, each of the set of target tracks does not contain all required media components for at least one preselection. Moreover, the second indication in the second data structure in each of the set of target tracks has the predetermined value. In one example, tracks containing a PreselectionGroupBox and not containing all required media components for at least one preselection shall have the track_in_movie flag set to ‘0’ in their track header boxes.

According to embodiments of the present disclosure, a non-transitory computer-readable recording medium is proposed. A bitstream of a video is stored in the non-transitory computer-readable recording medium. The bitstream can be generated by a method performed by a video processing apparatus. According to the method, a conversion between the bitstream and a media file of the video is performed. The media file comprises a group of labels comprising a first label. A first indication in a first data structure for the first label is coded with a single bit, and the first indication indicates whether the first label contains a summary label for the group of labels.

According to embodiments of the present disclosure, a method for storing a bitstream of a video is proposed. In the method, a conversion between the bitstream and a media file of the video is performed. The media file comprises a group of labels comprising a first label. A first indication in a first data structure for the first label is coded with a single bit, and the first indication indicates whether the first label contains a summary label for the group of labels. Moreover, the bitstream is stored in the non-transitory computer-readable recording medium.

According to embodiments of the present disclosure, another non-transitory computer-readable recording medium is proposed. A media file of a video is stored in the non-transitory computer-readable recording medium. The bitstream can be generated by a method performed by a video processing apparatus. According to the method, a conversion between a bitstream of the video and the media file is performed. The media file comprises a group of labels comprising a first label. A first indication in a first data structure for the first label is coded with a single bit, and the first indication indicates whether the first label contains a summary label for the group of labels.

According to embodiments of the present disclosure, a method for storing a media file of a video is proposed. In the method, a conversion between a bitstream of the video and the media file is performed. The media file comprises a group of labels comprising a first label. A first indication in a first data structure for the first label is coded with a single bit, and the first indication indicates whether the first label contains a summary label for the group of labels. Moreover, the media file is stored in the non-transitory computer-readable recording medium.

Implementations of the present disclosure can be described in view of the following clauses, the features of which can be combined in any reasonable manner.

Clause 1. A method for video processing, comprising: performing a conversion between a bitstream of a video and a media file of the video, wherein the media file comprises a group of labels comprising a first label, a first indication in a first data structure for the first label is coded with a single bit, and the first indication indicates whether the first label contains a summary label for the group of labels.

Clause 2. The method of clause 2, wherein the first data structure is a label box, and the first indication is an is_group_label field.

Clause 3. The method of any of clauses 1-2, wherein the group of labels have the same identifier, and the summary label comprises a summary or a title of all of the group of labels.

Clause 4. The method of any of clauses 1-3, wherein a predetermined number of bits immediately following the single bit are reserved.

Clause 5. The method of any of clauses 1-3, wherein a predetermined number of bits immediately preceding the single bit are reserved.

Clause 6. The method of any of clauses 4-5, wherein the predetermined number is 7.

Clause 7. The method of any of clauses 1-6, wherein a requirement specifying that a second indication in a second data structure in a track has a predetermined value is not imposed on at least one track in the media file, the second indication indicates whether the corresponding track represents a direct part of a presentation of the media file, the second data structure specifies characteristics of the corresponding track, and the at least one track does not contribute to a preselection for the media file.

Clause 8. The method of clause 7, wherein the second indication is a track_in_movie flag, the second data structure is a track header box, and the predetermined value is 0.

Clause 9. The method of any of clauses 7-8, wherein the at least one track does not contain a track group type box with a track group type field equal to ‘pres’.

Clause 10. The method of clauses 7-9, wherein a track group type box with a track group type field equal to ‘pres’ is a preselection group box.

Clause 11. The method of clause 10, wherein the media file comprises a set of target tracks, each of the set of target tracks contains the preselection group box and lacks one or more required media components for at least one preselection for the media file, and the second indication in the second data structure in each of the set of target tracks has the predetermined value.

Clause 12. The method of any of clauses 1-11, wherein the media file is of an international organization for standardization (ISO) base media file format.

Clause 13. The method of any of clauses 1-12, wherein the conversion comprises generating the media file and storing the bitstream to the media file.

Clause 14. The method of any of clauses 1-12, wherein the conversion comprises parsing the media file to reconstruct the bitstream.

Clause 15. An apparatus for processing video data comprising a processor and a non-transitory memory with instructions thereon, wherein the instructions upon execution by the processor, cause the processor to perform a method in accordance with any of clauses 1-14.

Clause 16. A non-transitory computer-readable storage medium storing instructions that cause a processor to perform a method in accordance with any of clauses 1-14.

Clause 17. A non-transitory computer-readable recording medium storing a bitstream of a video which is generated by a method performed by a video processing apparatus, wherein the method comprises: performing a conversion between the bitstream and a media file of the video, wherein the media file comprises a group of labels comprising a first label, a first indication in a first data structure for the first label is coded with a single bit, and the first indication indicates whether the first label contains a summary label for the group of labels.

Clause 18. A method for storing a bitstream of a video, comprising: performing a conversion between the bitstream and a media file of the video; and storing the bitstream in a non-transitory computer-readable recording medium, wherein the media file comprises a group of labels comprising a first label, a first indication in a first data structure for the first label is coded with a single bit, and the first indication indicates whether the first label contains a summary label for the group of labels.

Clause 19. A non-transitory computer-readable recording medium storing a media file of a video which is generated by a method performed by a video processing apparatus, wherein the method comprises: performing a conversion between a bitstream of the video and the media file, wherein the media file comprises a group of labels comprising a first label, a first indication in a first data structure for the first label is coded with a single bit, and the first indication indicates whether the first label contains a summary label for the group of labels.

Clause 20. A method for storing a media file of a video, comprising: performing a conversion between a bitstream of the video and the media file; and storing the media file in a non-transitory computer-readable recording medium, wherein the media file comprises a group of labels comprising a first label, a first indication in a first data structure for the first label is coded with a single bit, and the first indication indicates whether the first label contains a summary label for the group of labels.

### Example Device

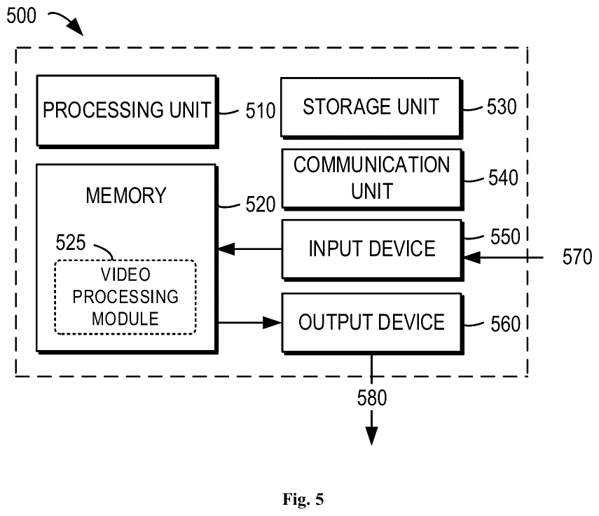

FIG. 5 illustrates a block diagram of a computing device 500 in which various embodiments of the present disclosure can be implemented. The computing device 500 may be implemented as or included in the source device 110 (or the video encoder 114 or 200) or the destination device 120 (or the video decoder 124 or 300).

It would be appreciated that the computing device 500 shown in FIG. 5 is merely for purpose of illustration, without suggesting any limitation to the functions and scopes of the embodiments of the present disclosure in any manner.

As shown in FIG. 5, the computing device 500 includes a general-purpose computing device 500. The computing device 500 may at least comprise one or more processors or processing units 510, a memory 520, a storage unit 530, one or more communication units 540, one or more input devices 550, and one or more output devices 560.

In some embodiments, the computing device 500 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 500 can support any type of interface to a user (such as “wearable” circuitry and the like).

The processing unit 510 may be a physical or virtual processor and can implement various processes based on programs stored in the memory 520. In a multi-processor system, multiple processing units execute computer executable instructions in parallel so as to improve the parallel processing capability of the computing device 500. The processing unit 510 may also be referred to as a central processing unit (CPU), a microprocessor, a controller or a microcontroller.

The computing device 500 typically includes various computer storage medium. Such medium can be any medium accessible by the computing device 500, including, but not limited to, volatile and non-volatile medium, or detachable and non-detachable medium. The memory 520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 530 may be any detachable or non-detachable medium and may include a machine-readable medium such as a memory, flash memory drive, magnetic disk or another other media, which can be used for storing information and/or data and can be accessed in the computing device 500.

The computing device 500 may further include additional detachable/non-detachable, volatile/non-volatile memory medium. Although not shown in FIG. 5, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 540 communicates with a further computing device via the communication medium. In addition, the functions of the components in the computing device 500 can be implemented by a single computing cluster or multiple computing machines that can communicate via communication connections. Therefore, the computing device 500 can operate in a networked environment using a logical connection with one or more other servers, networked personal computers (PCs) or further general network nodes.

The input device 550 may be one or more of a variety of input devices, such as a mouse, keyboard, tracking ball, voice-input device, and the like. The output device 560 may be one or more of a variety of output devices, such as a display, loudspeaker, printer, and the like. By means of the communication unit 540, the computing device 500 can further communicate with one or more external devices (not shown) such as the storage devices and display device, with one or more devices enabling the user to interact with the computing device 500, or any devices (such as a network card, a modem and the like) enabling the computing device 500 to communicate with one or more other computing devices, if required. Such communication can be performed via input/output (I/O) interfaces (not shown).

In some embodiments, instead of being integrated in a single device, some or all components of the computing device 500 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 500 may be used to implement video encoding/decoding in embodiments of the present disclosure. The memory 520 may include one or more video processing modules 525 having one or more program instructions. These modules are accessible and executable by the processing unit 510 to perform the functionalities of the various embodiments described herein.

In the example embodiments of performing video encoding, the input device 550 may receive video data as an input 570 to be encoded. The video data may be processed, for example, by the video processing module 525, to generate an encoded bitstream. The encoded bitstream may be provided via the output device 560 as an output 580.

In the example embodiments of performing video decoding, the input device 550 may receive an encoded bitstream as the input 570. The encoded bitstream may be processed, for example, by the video processing module 525, to generate decoded video data. The decoded video data may be provided via the output device 560 as the output 580.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
performing a conversion between a bitstream of a video and a media file of the video,
wherein the media file comprises a group of labels comprising a first label, a first indication in a first data structure for the first label is coded with a single bit, and the first indication indicates whether the first label contains a summary label for the group of labels.

2. The method of claim 1, wherein the first data structure is a label box, and the first indication is an is_group_label field.

3. The method of claim 1, wherein the group of labels have the same identifier, and the summary label comprises a summary or a title of all of the group of labels.

4. The method of claim 1, wherein a predetermined number of bits immediately following the single bit are reserved.

5. The method of claim 1, wherein a predetermined number of bits immediately preceding the single bit are reserved.

6. The method of claim 4, wherein the predetermined number is 7.

7. The method of claim 1, wherein a requirement specifying that a second indication in a second data structure in a track has a predetermined value is not imposed on at least one track in the media file, the second indication indicates whether the corresponding track represents a direct part of a presentation of the media file, the second data structure specifies characteristics of the corresponding track, and the at least one track does not contribute to a preselection for the media file.

8. The method of claim 7, wherein the second indication is a track_in_movie flag, the second data structure is a track header box, and the predetermined value is 0.

9. The method of claim 7, wherein the at least one track does not contain a track group type box with a track group type field equal to ‘pres’.

10. The method of claim 7, wherein a track group type box with a track group type field equal to ‘pres’ is a preselection group box.

11. The method of claim 10, wherein the media file comprises a set of target tracks, each of the set of target tracks contains the preselection group box and lacks one or more required media components for at least one preselection for the media file, and the second indication in the second data structure in each of the set of target tracks has the predetermined value.

12. The method of claim 1, wherein the media file is of an international organization for standardization (ISO) base media file format.

13. The method of claim 1, wherein the conversion comprises generating the media file and storing the bitstream to the media file.

14. The method of claim 1, wherein the conversion comprises parsing the media file to reconstruct the bitstream.

15. An apparatus for processing video data comprising a processor and a non-transitory memory with instructions thereon, wherein the instructions upon execution by the processor, cause the processor to perform acts comprising:
performing a conversion between a bitstream of a video and a media file of the video,
wherein the media file comprises a group of labels comprising a first label, a first indication in a first data structure for the first label is coded with a single bit, and the first indication indicates whether the first label contains a summary label for the group of labels.

16. The apparatus of claim 15, wherein the first data structure is a label box, and the first indication is an is_group_label field, or
wherein the group of labels have the same identifier, and the summary label comprises a summary or a title of all of the group of labels, or
wherein a predetermined number of bits immediately following the single bit are reserved.

17. A non-transitory computer-readable storage medium storing instructions that cause a processor to perform acts comprising:
performing a conversion between a bitstream of a video and a media file of the video,
wherein the media file comprises a group of labels comprising a first label, a first indication in a first data structure for the first label is coded with a single bit, and the first indication indicates whether the first label contains a summary label for the group of labels.

18. The non-transitory computer-readable storage medium of claim 17, wherein the first data structure is a label box, and the first indication is an is_group_label field, or
wherein the group of labels have the same identifier, and the summary label comprises a summary or a title of all of the group of labels, or
wherein a predetermined number of bits immediately following the single bit are reserved.

19. A non-transitory computer-readable recording medium storing a media file of a video which is generated by a method performed by a video processing apparatus, wherein the method comprises:
performing a conversion between a bitstream of the video and the media file,
wherein the media file comprises a group of labels comprising a first label, a first indication in a first data structure for the first label is coded with a single bit, and the first indication indicates whether the first label contains a summary label for the group of labels.

20. The non-transitory computer-readable recording medium of claim 19, wherein the first data structure is a label box, and the first indication is an is_group_label field, or
wherein the group of labels have the same identifier, and the summary label comprises a summary or a title of all of the group of labels, or
wherein a predetermined number of bits immediately following the single bit are reserved.
